(19) United States
(12) Patent Application Publication
(10) Pub. No.: US 2010/0192990 A1
(43) Pub. Date: Aug. 5, 2010

(54) DISHWASHER PLATFORM

(75) Inventors: Dieter Hotz, Dischingen (DE); Cengiz Kücük, Syrgenstein (DE); Anton Oblinger, Wertingen (DE); Michael Rosenbauer, Reimlingen (DE); Bernd Schessl, Dillingen (DE); Manfred Seessle, Gerstetten (DE); David Semerad, Holzheim (DE); Martin Stickel, Giengen/Brenz (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERATE GMBH, Munich (DE)

(21) Appl. No.: 12/665,344

(22) PCT Filed: Jun. 13, 2008
(86) PCT No.: PCT/EP08/57459

§ 371 Date: Dec. 18, 2009

(30) Foreign Application Priority Data
Jun. 29, 2007 (DE) 10 2007 030 064.8

(51) Int. Cl. A47L 15/00; B23P 17/04

(52) U.S. Cl. 134/115 R; 29/428

(57) ABSTRACT

A dishwasher having a washing compartment that is formed by a trough section and a base section. The dishwasher also has a connecting frame that is disposed between the trough section and the base section.

The invention relates to a dishwasher, comprising a walled trough section which is open to the front and bottom, said trough section being disposed on a base section to form a washing compartment and a bottom wall of the washing compartment being formed by the base section. The invention also relates to a method for manufacturing a dishwasher, comprising a walled trough section which is open to the front and bottom, said trough section being disposed on a base section to form a washing compartment and a bottom wall of the washing compartment being formed by the base section.

The basic structure of a dishwasher, in particular a domestic dishwasher, is known as a platform. The platform of a dishwasher essentially comprises the washing compartment and the means of supporting the washing compartment on the base, e.g. using a metal or plastic mounting base. In some circumstances, in addition to the above, the term platform is also understood as meaning the method or possibility of installing functional components, e.g. pumps, heater, electrical or hydraulic connectors, filters or water softener, and/or as meaning the housing.

The following platform is known from the prior art: a washing compartment is placed on a plastic mounting base. The washing compartment with two sidewalls, a back wall, a bottom wall and a top wall (i.e. only open to the front) consists entirely of stainless steel and is fabricated from in general a plurality of stainless steel sheets by means of forming and joining processes, e.g. welding. The mounting base is therefore a tray which is open to the top, as described e.g. in EP 0 243 632 A2 and EP 0 243 631 B1 of the applicant.

As a further development, EP 0 452 287 B1 discloses a washing compartment which only has two sidewalls, a back wall and a top wall of stainless steel (trough section) and the bottom wall of the washing compartment is formed by the plastic mounting base, i.e. the mounting base is therefore not a tray open to the top as in EP 0 243 632 A2 and EP 0 243 631 131 but a box essentially closed on all sides.

DE 101 56 423 A1 of the applicant likewise discloses a platform with a washing compartment consisting of two sidewalls, a back wall and a top wall of stainless steel. The bottom wall of the washing compartment is likewise formed by the plastic mounting base.

Said platform concepts, in particular known from EP 0 452 287 B1 and DE 101 56 423 A1 of the applicant, in which the plastic mounting base forms the bottom wall of the washing compartment and having a separate housing, are cheaper and simpler to manufacture. However, the disadvantage of the two abovementioned platforms is that, inside the washing compartment, i.e. after assembly of the dishwasher, plastic and not stainless steel is visible on the washing compartment's bottom wall surface visible to the ultimate consumer. The ultimate consumer regards the use of stainless steel in the washing compartment as a particular quality feature, so that this platform concept appears to the ultimate consumer or user of the dishwasher as being subjectively of lower quality.

EP 0 556 787 B2 discloses a platform with an upper section, containing two sidewalls, a top wall and a back wall, in which the housing and the part of the washing compartment formed by the upper section constitute an entity and are double walled, i.e. made in one piece from plastic and are placed on a mounting floor as a base, likewise made of plastic. This is therefore a platform concept different from that described above, which particularly because of the use of plastic and the interconnection between housing and washing compartment as a twin-wall plastic part on the upper section, differs from the abovementioned prior art. For visual refinement, at least part of the visible surface of the floor of the washing compartment, which is of a piece with the plastic base, can have a metallic surface.

The object of the present invention is therefore to provide a dishwasher having a platform which is inexpensive and simple to manufacture on the one hand and, on the other, can flexibly represent different platform concepts. The object is also to specify a method for manufacturing such a dishwasher.

This object is achieved by an inventive dishwasher as claimed in claim 1 and an inventive method for manufacturing a dishwasher as claimed in claim 44. Advantageous embodiments are set forth in the dependent claims.

In an inventive dishwasher, comprising a walled trough section which is open to the front and bottom, said trough section being disposed on a base section to form a washing compartment and a bottom wall of the washing compartment being formed by the base section, the base section incorporates, as a separate component, a connecting frame to the bottom wall of the washing compartment.

In a particular embodiment, the base section comprises a base support.

The base support is preferably a single-part frame structure.

In another embodiment, the base support comprises two foot module bars.

In particular, the base section comprises a floor (drip) tray.

In a supplementary embodiment, the connecting frame consists of one or more parts, in particular two.

In a further embodiment, the bottom wall on the connecting frame in the visible region of the washing compartment is formed at least partly by a foil or an insert of non-corrodible metal, in particular stainless steel, or plastic or by a metal sheet of non-corrodible metal, in particular stainless steel, and these parts are connected to the rest of the connecting frame via corresponding interfaces.

A frame is preferably mounted on the front end of the sidewalls and top wall of the trough section.

In a supplementary embodiment, the connecting frame comprises interfaces for connection to part of the bottom wall and/or for connection to the base support and/or for connection to the frame and/or for connection to the trough section.

In an additional embodiment, the base support incorporates interfaces for connection to the floor tray and/or for connection to the connecting frame.

The floor tray is preferably used for collecting leakage water and/or as a protection device against in particular mechanical damage to functional components.

In another embodiment, the floor tray comprises interfaces for connection to the base support.

In particular, the frame comprises interfaces for connection to the connecting frame.

In a supplementary embodiment, the trough section comprises a back wall, a left-hand sidewall, a right-hand sidewall and a top wall.

The trough section preferably consists at least partially of non-corrodible metal, e.g. stainless steel, or plastic.

In another embodiment, the base section consists at least partially of plastic, in particular thermoplastic plastic.

In an additional embodiment, the connecting frame to a liquid-tight, closed bottom wall comprises a foil, e.g. metal foil, in particular stainless steel foil, e.g. made of nickel-chromium steel, or plastic foil of preferably thermoplastic plastic with stainless steel effect in the area of the visible part of the washing compartment.

In a supplementary embodiment, the foil is bonded to the connecting frame during injection molding of the plastic connecting frame, in particular by inserting the foil in the mold prior to injection molding.

In another embodiment, the connecting frame comprises an insert of non-corrodible metal, in particular stainless steel, e.g. nickel-chromium steel, which is placed on a plastic bottom wall of the connecting frame with or without liquid-tight sealing against the plastic bottom wall of the connecting frame or the insert is disposed spaced apart from the plastic bottom wall of the connecting frame, in particular with a gap being formed, e.g. with the aid of spacers.

In another embodiment, a liquid-tight, closed bottom wall of the connecting frame preferably of plastic is present.

The insert is preferably sealed to the connecting frame using sealing elements e.g. made of an elastomer such as EPDM or TPE, or an elastomer such as silicone.

In a supplementary embodiment, the bottom wall of the connecting frame is constituted at least partially by a non-corrodible metal sheet or insert, in particular of stainless steel, e.g. nickel-chromium steel, or of plastic, the metal sheet or the insert being sealed to the connecting frame e.g. by at least one adhesive section or area or by a gap-free bond between the metal sheet or insert, e.g. produced by back injection molding.

In particular, the insert is connected to the connecting frame via at least one snap-lock mechanism.

In another embodiment, the metal sheet or insert is sealed to the connecting frame using sealing elements, e.g. a TPE seal injected on the connecting frame.

The bottom wall of the connecting frame preferably has at least one opening.

In an additional embodiment, the connecting frame consists completely of non-corrodible metal, in particular stainless steel, e.g. nickel-chromium steel, and a liquid-tight closed bottom wall of the connecting frame is implemented.

In another embodiment, the base support absorbs most of the forces arising on the base section.

The arrangements of metal foil, metal sheet and/or insert on the bottom wall of the connecting frame are preferably combined with one another.

In a supplementary embodiment, the housing is disposed separately from the trough section and/or base section.

In particular, the housing is not connected to the trough section and/or base section over a large surface area, i.e. the housing constitutes a component that is independent of the trough section.

In another embodiment, the housing is connected to a frame structure and/or the washing compartment and/or the base section at isolated points or more specifically with minimal bearing surfaces, using fixing means such as screwing, riveting or clamping.

The housing preferably consists of at least one wall, e.g. of coated metal sheets, and preferably comprises two housing sidewalls and an upper housing wall.

In an additional embodiment, the walls are disposed a slight distance, e.g. ranging from 0.1 to 7 cm, from the walls of the trough section and/or the walls of the base section, in particular of the base support.

In particular, the base section, in particular the base support, is implemented as a shell structure comprising a bottom wall of the washing compartment, a back wall, two sidewalls, a bottom wall and preferably a front wall.

In another embodiment, the walls of the base section, in particular of the base support, have openings for repair and maintenance purposes.

In an additional embodiment, the base section, in particular a base support, is implemented as a frame structure.

In general, the invention relates to a domestic dishwasher.

This is preferably a built-in, freestanding or built-under dishwasher or a fully integrated dishwasher, but not a compact or tabletop dishwasher.

In another embodiment, the base section, in particular the base support, incorporates interfaces for connection to functional components, e.g. pumps, valves, electrical or hydraulic connectors or electrical switches, i.e. the base section is a mounting base.

In a supplementary embodiment, fixings for functional components, e.g. pump, heater, electrical or hydraulic connectors, filter, pump sump or water softener or functional components are injection molded to the base section or parts of the base section, e.g. the connecting frame, a base support or a floor tray.

In an additional embodiment, fixings for functional components, e.g. pump, heater, electrical or hydraulic connectors, filter, pump sump, heat exchanger or water softener, or functional components are injection molded to the trough section, e.g. the walls.

In an inventive method for manufacturing a dishwasher, comprising a walled trough section which is open to the front and bottom, said trough section being disposed on a base section to form a washing compartment and a bottom wall of the washing compartment being formed by the base section, the trough section is fixed to a connecting frame as a separate component and the connecting frame comprises the bottom wall.

The connecting frame is preferably fixed on a base support via interfaces.

In another embodiment, a floor tray is fixed to the base support via interfaces.

In another embodiment, a frame is fixed via interfaces to the front end of a left-hand and right-hand washing compartment wall and a washing compartment top wall.

In particular, the frame and the connecting frame is first fixed to the trough section and then the base support is attached thereto.

In a supplementary embodiment, the floor tray is fixed to the base support.

Preferably, the frame is first fixed to the trough section and then the connecting frame with the base support is attached thereto.

In another embodiment, the floor tray is fixed to the base support.

In another embodiment, the plastic parts of the base section are produced by injection molding.

The plastic walls of the trough section are preferably produced by injection molding.

In a supplementary embodiment, fixings for functional components, e.g. pump, heater, electrical or hydraulic connectors, filter, pump sump or water softener, or functional components, are injection molded to parts of the base section, e.g. the connecting frame, a base support or a floor tray.

In a supplementary embodiment, fixings for functional components, e.g. pump, heater, electrical or hydraulic connectors, filter, pump sump, heat exchanger or water softener or functional components are injection molded to the trough section, e.g. the walls.

The invention will now be explained in greater detail with reference to the accompanying drawings in which:

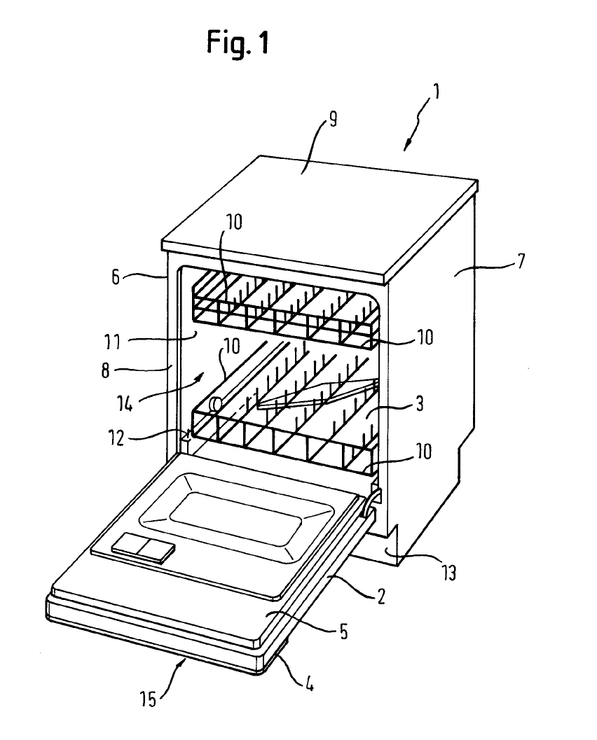

FIG. 1 shows a perspective view of a dishwasher according to the invention,

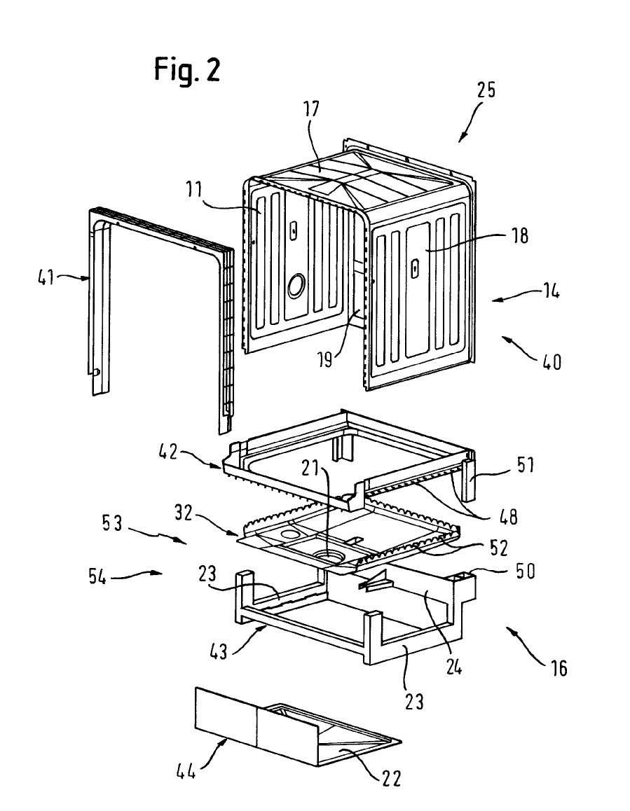

FIG. 2 shows a perspective view of a platform of a dishwasher according to the invention,

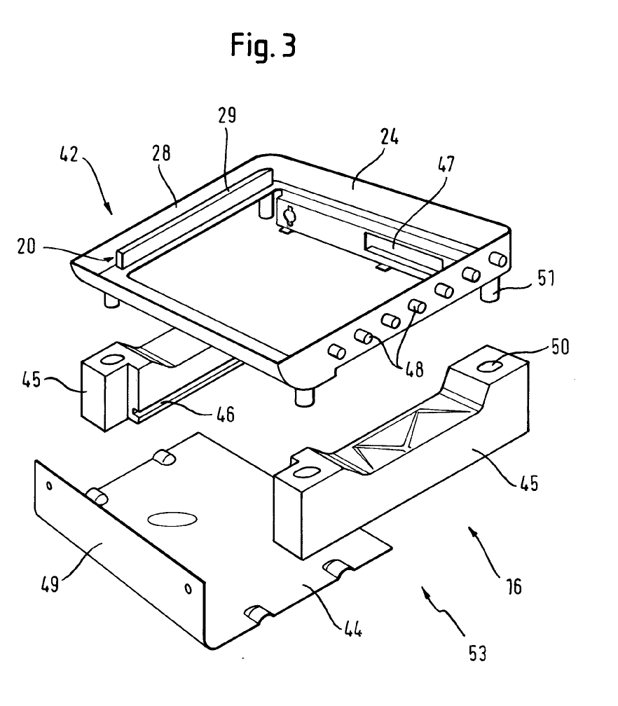

FIG. 3 shows a perspective view of the base section without bottom wall of a platform of a dishwasher according to the invention in another embodiment,

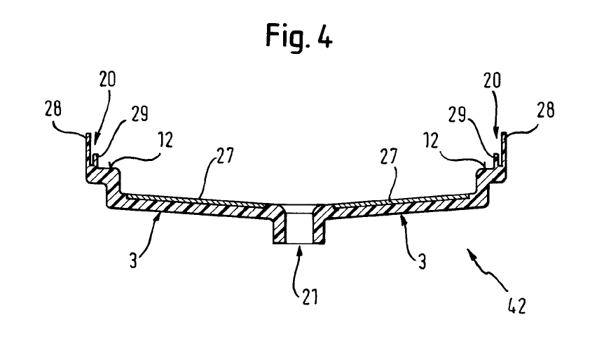

FIG. 4 shows a longitudinal section through a connecting frame as a closed variant,

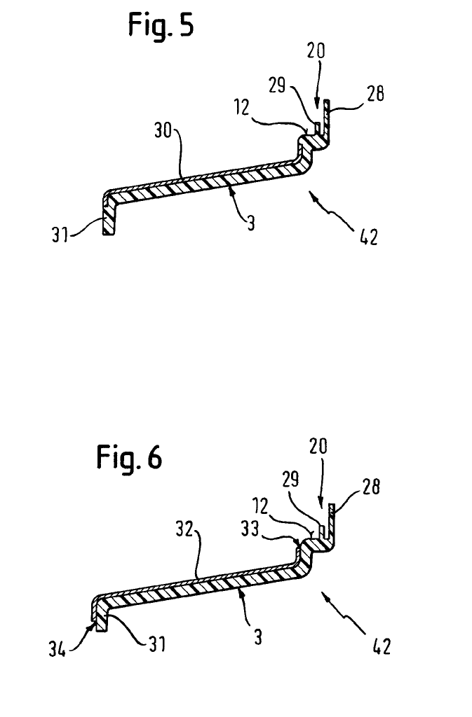

FIG. 5 shows a longitudinal section through one half of a connecting frame as a closed variant in another embodiment,

FIG. 6 shows a longitudinal section through one half of a connecting frame as a closed variant in another embodiment,

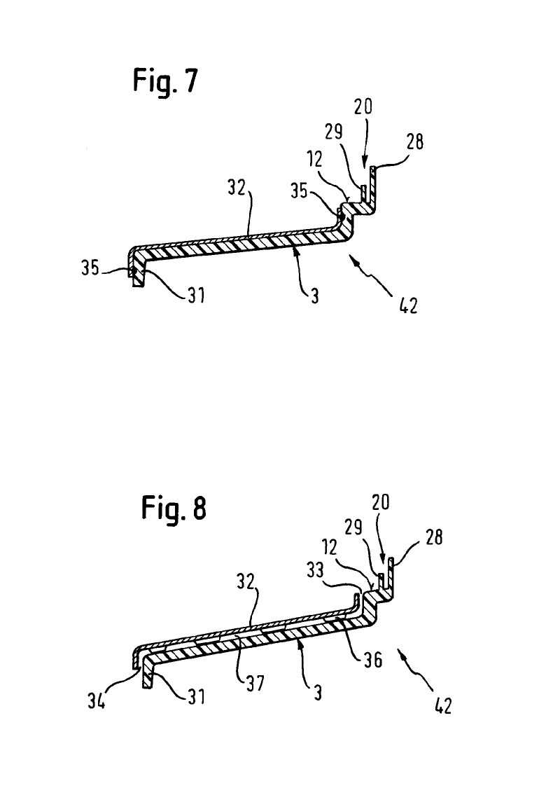

FIG. 7 shows a longitudinal section through one half of a connecting frame as a closed variant in another embodiment,

FIG. 8 shows a longitudinal section through one half of a connecting frame as a closed variant in another embodiment,

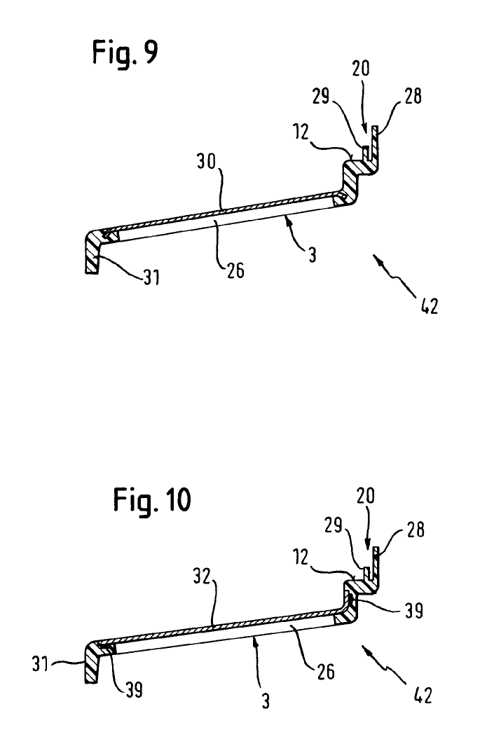

FIG. 9 shows a longitudinal section through one half of a connecting frame as an open variant,

FIG. 10 shows a longitudinal section through one half of a connecting frame as an open variant in another embodiment and

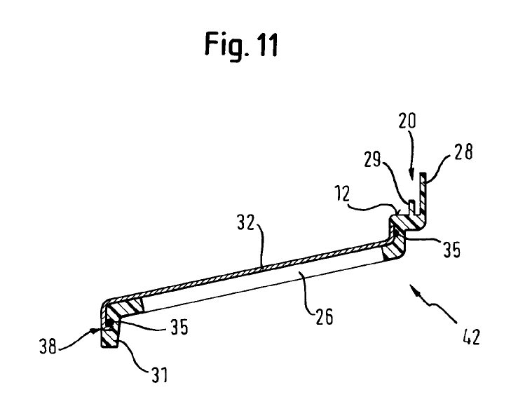

FIG. 11 shows a longitudinal section through one half of a connecting frame as an open variant in another embodiment.

FIG. 1 shows a perspective view of an inventive dishwasher 1. The inventive dishwasher 1 has a door 15 hinged about a horizontal axis for opening and closing the washing compartment 14 with an upper and lower dish rack 10 for accommodating the items to be washed, e.g. household utensils. The lower rack moves on rollers on a correspondingly shaped track 12. The door 15 is constructed of an inner door 5 made of formed stainless steel sheet and an outer door 2 disposed at a distance from the inner door 5 as an exterior panel or housing. In the case of a built-in or built-under dishwasher, an additional panel matching the kitchen unit can also be mounted on the outer door 2. A base panel 13 is disposed below the door 2. A control panel 4 for operating the dishwasher 1 is located on the upper part of the outer door 2. For the external housing of the dishwasher 1, a left-hand housing sidewall 6, a right-hand housing sidewall 7 and an upper housing wall 9 are disposed around the washing compartment 14 and the base section 53 disposed below the washing compartment 14.

There is a small interspace, e.g. ranging from 0.1 to 12 cm, between the walls 11, 17, 18 (some not shown) of the washing compartment 14 and the housing walls 6, 7, 9, the latter consisting of coated sheet metal parts, for example. Between the housing walls 6, 7, 9 and the walls 11, 17, 18 (some not shown) of the washing compartment 14, a single- or multi-part front panel 8 is mounted at the opening to the washing compartment 14. The housing walls 6, 7, 9 are fixed to the washing compartment 14 or trough section 40 and/or supporting frame parts, in particular made of metal (not shown), via fasteners such as screws. The housing is therefore separate from the washing compartment 14, i.e. the walls of the washing compartment 14 are not in connection with the housing over a large surface area and the housing sidewalls 6, 7, 9 are spaced slightly apart from washing compartment 14.

Part of the washing compartment 14 as a trough section 40 open to the front and bottom (FIG. 2) is formed by a left-hand washing compartment wall 11, a right-hand washing compartment wall 18 (not shown), a washing compartment back wall 19 and a washing compartment top wall 17 each made from interconnected stainless steel sheets by joining processes, e.g. welding, see FIG. 2. The bottom wall 3 is part of a connecting frame 42 which is part of the base section 53. In order to achieve a metallic appearance also in the bottom of the washing compartment 14, in particular a stainless steel surface, an insert 32 of non-corrodible metal or a stainless steel insert, e.g. a deep-drawn stainless steel sheet, is molded into the connecting frame 42, preferably in the visible area. The possibilities, in particular interfaces, available here will be explained below by way of example.

FIG. 2 shows a perspective view of a platform 25 (base section 53 and trough section 40 of the washing compartment 14) of a dishwasher 1 according to the invention. The bottom wall 3 of the washing compartment 14 is formed by an insert 32 and the connecting frame 42. The base section 53 comprises the connecting frame 42 with insert 32, a base support 43 and a floor tray 44. The base support 43 constitutes the supporting part of the platform 25. The base support 43 preferably contains mounts (not shown in FIG. 2) for functional components, e.g. pumps, heater, electrical or hydraulic connectors. In so far as the base section 53, in particular the base support 43, contains mounts for functional components, the base section 53 also represents a mounting base 16, i.e. functional components can be mounted in the base section 53. To accommodate the connecting frame 42, i.e. the washing compartment base 54, the base support 43 has interfaces 50 which can be implemented e.g. as oblong recesses of rectangular or square cross section.

The bottom wall 3 of the washing compartment 14 consists of the preferably plastic connecting frame 42 and the insert 32 of non-corrodible metal, in particular stainless steel or plastic. The connecting frame 42 and the insert 32 are interconnected via interfaces 48, 52. For example, plastic cylindrical thermal rivets 48 can be implemented on the connecting frame 42 and, on the insert 32, U-shaped recesses can be implemented on the upwardly curved, vertically oriented part of the insert 32 for this purpose. When the connecting frame 42 has been placed on the insert 32, the thermal rivets 48 are disposed in the U-shaped recesses of the insert 32. A heated riveting die melts the plastic thermal rivets 48 so that a substance-to-substance bond is produced between the insert 32 and the connecting frame 42. Further variants of possibilities for interfaces between the connecting frame 42 and the insert 32 will be explained below.

On the connecting frame 42, an interface 51 is implemented as a foot 51 of rectangular cross section for connection to the base support 43. On the connecting frame 42 there is also an interface 20 for connection to the trough section 40 e.g. in the form of a groove-shaped receptacle 20 (FIG. 3 and FIG. 4) having an outer groove wall 28 and an inner groove wall 29. A left-hand and right-hand washing compartment wall 11, 18 and a washing compartment back wall 19 is inserted in the groove-shaped receptacle 20 and e.g. bonded and/or screwed to the connecting frame 42. The connecting frame 42 also contains an interface for receiving a frame 41.

The frame 41 is positioned at the front end of the left-hand and right-hand washing compartment sidewall 11, 19 and of a washing compartment top wall 17. The frame 41 is used e.g. for reinforcement of the platform 25. The frame 41 consists of non-corrodible metal, in particular stainless steel, plastic or a metal-plastic composite, in particular a stainless steel-plastic composite (hybrid frame).

The plastic parts 42, 43, 44 of the base section 53 are preferably inexpensively manufactured by injection molding from a thermoplastic plastic, e.g. polypropylene (PP). The left-hand washing compartment sidewall 11, the right-hand washing compartment sidewall 18, the washing compartment top wall 17 and the washing compartment back wall 19 of the trough section 40 consist of non-corrodible metal, e.g. chromium steel or stainless steel, e.g. nickel-chromium steel, but at least one wall 11, 17, 18, 19 of the trough section 40 can also consist of a material other than stainless steel, e.g. the washing compartment top wall 17 can be plastic. These are e.g. formed stainless steel sheets which are interconnected by joining processes such as welding.

The base section 53 has the bottom wall 3 of the washing compartment 14, a back wall 24, two sidewalls 23 and a bottom wall 22. A drainage sump 21 is implemented in the bottom wall 3. The walls 22, 23, 24 of the mounting base 16 can also have smaller or larger openings, e.g. for repair or maintenance purposes. In the case of larger openings, the mounting base 16 can also have more of a frame structure than a shell structure.

FIG. 3 shows another embodiment of a base section 53 without insert 32. The connecting frame 42 has on the upper side a groove-shaped receptacle 20 as an interface 20 for connection to the trough section 40. The groove-shaped receptacle consists of an outer groove wall 28 and an inner groove wall 29. The back wall 24 of the connecting frame 42 has a receptacle 47, implemented as a recess on the back wall 24, for a counterweight in the dishwasher 1 according to the invention. Thermal rivets 48 are implemented on the left-hand (not shown) and right-hand part of the connecting frame 42. An interface 51 as a foot 51 of circular cross section is provided on the underside at the corners of the connecting frame 42. The base support 43 consists of two foot module bars 45. Two interfaces 50 as oblong recesses 50 of circular cross section are provided on the upper side of the foot module bars 45. The foot module bars also have a receiving gap 46 for the floor tray 44. The floor tray 44 has a front vertical sub-section as a cover 49 for the base area.

The components of the platform 25, in particular the trough section 40 comprising walls 11, 17, 18, 19, the frame 41 and the base section 53, comprising the connecting frame 42, the base support 43 and the floor tray 44, can be made from any materials, in particular non-corrodible metal, e.g. stainless steel, or plastic, and these components 11, 17, 18, 19, 41, 42, 44, 53 can be combined with one another and/or assembled in any order. For example, a trough section 40 with frame 41 can be pre-assembled and placed on the base section 53 during final assembly or a trough section 40 with frame 41 and connecting frame 42 including bottom wall 3 can be pre-assembled and mounted on the base support 43 during final assembly.

The subsequent FIGS. 4 to 11 describe various exemplary embodiments of a base section 53. These involve in particular different interfaces for connecting the plastic or metal insert 32 to the connecting frame 42. A distinction is basically drawn between a variant of a closed base section 53 in FIGS. 3 to 7 and that of an open base section 53 in FIGS. 8 to 10. In the variant of the closed base section 53, the part not belonging to the insert 32 of the bottom wall 3 of the washing compartment 14, made of plastic of the connecting frame 42, has no openings 26, i.e. is closed as shown in FIG. 4. In contrast thereto is the variant of the open base section 53 which has openings 26 in the part not belonging to the insert 32 of the bottom wall 3 of the washing compartment 14 made of plastic of the connecting frame 42.

FIG. 4 shows a longitudinal section through the connecting frame 42 of the base section 53 as a closed variant. A non-corrodible foil 27, e.g. metal foil 27, in particular stainless steel metal foil 27, e.g. of nickel-chromium steel, or plastic foil with stainless steel effect is inserted in the bottom wall 3 of the washing compartment 14. For this purpose, during injection molding of the connecting frame 42 of thermoplastic plastic, the foil 27 is inserted into the mold prior to introducing the melted and homogenized plastic and the foil 27 is then bonded to the rest of the connecting frame 42 by back injection molding. The foil 27 can also be disposed (not shown) over a larger or the entire area of the visible part of the bottom wall 3 of the washing compartment, e.g. as far as the track 12. The longitudinal section in FIG. 4 also shows the drainage sump 21, the track 12 for the lower dish rack 10 (not shown) and the outer groove wall 28 and the inner groove wall 29 for the groove-shaped receptacle 20. The seal tightness and stability of the bottom wall 3 of the connecting frame 42 as part of the washing compartment 14 is ensured by the part of the bottom wall 3 that is not part of the foil 27, so that the foil 27 can even be damaged without compromising the seal-tightness.

In the subsequent FIGS. 5 to 11, analogously to FIG. 4 only the right-hand part of the connecting frame 42 is shown for reasons of simplification.

FIG. 5 shows a longitudinal section through one half of the connecting frame 42 of the base section 53 as a closed variant in another embodiment. A pre-formed, e.g. deep-drawn, non-corrodible metal sheet 30, in particular a stainless steel sheet, e.g. of nickel-chromium steel, is inserted into the bottom wall 3 of the connecting frame 42. For this purpose, the metal sheet 30 is inserted in the mold prior to injection molding and then back injection molded with plastic, thereby producing a liquid-tight bond between the metal sheet 30 and the remaining plastic section of the bottom wall 3 of the washing compartment 14 on the connecting frame 42. The left-hand end in FIG. 5 corresponds to the area 31 of the drainage sump 21.

FIG. 6 shows a longitudinal section through one half of the connecting frame 42 of the base section 53 as a closed variant in another embodiment with an insert 32 as a pre-formed non-corrodible metal sheet 32, in particular a stainless steel sheet 32, e.g. of nickel-chromium steel. The insert 32 is not back injection molded, but placed on top of the plastic part of the bottom wall 3, i.e. there is an open interlocking between insert 32 and connecting frame 42. In some circumstances, the insert 32 is preferably fixed pointwise to the plastic part of the bottom wall 3 of the connecting frame 42. There is therefore a liquid-tight connection between the insert 32 and the bottom wall 3 so that rinsing water can enter e.g. at a entry point 33 between the insert 32 and the surface of the plastic part of the bottom wall 3. However, once it has entered, the rinsing water can drain into the drainage sump 21 at an outlet point 34, i.e. in the area 31 of the drainage sump 21. Because of the closed variant of the connecting frame 42, the washing compartment 14 is therefore still liquid-tight. In some circumstances, the insert 32 can be additionally fixed, e.g. by means of a fine filter in the drainage sump 21 (not shown). The open interlocking, i.e. the placing of the insert 32 on top of the bottom wall 3 as part of the plastic connecting frame 42, has the advantage that during fabrication and assembly processes the insert 32 can be mounted to the connecting frame 42 at the optimum point in time so that greater manufacturing flexibility can be achieved.

FIG. 7 shows a longitudinal section through one half of the connecting frame 42 of the base section 53 as a closed variant in another embodiment having a sealed insert 32 as a pre-formed, e.g. deep-drawn, non-corrodible metal sheet 32, in particular a stainless steel sheet 32, e.g. of nickel-chromium steel. Analogously to the embodiment shown in FIG. 6, the insert 32 is placed on top of the plastic part of the bottom wall 3. However, sealing elements 35, e.g. an elastomer such as EPDM or TPE, or flat sealing material such as silicone, are provided between the insert 32 and the surface of the plastic part of the bottom wall 3 so that no rinsing water can penetrate between the insert 32 and the surface of the bottom wall 3. In addition, an insulation, e.g. of bitumen, can be inserted between the insert 32 and the connecting frame 42, thereby ensuring that, because of the sealing provided, the insulation does not come into contact with the rinsing water. The sealing element 35 in the area 31 of the drainage sump 21 is optional.

FIG. 8 shows a longitudinal section through one half of the connecting frame 42 of the base section 53 as a closed variant in another embodiment having a spaced insert 32 as a preformed non-corrodible metal sheet 32, in particular a stainless steel sheet 32, e.g. of nickel-chromium steel. With the aid of spacers 36, e.g. in the form of indentations on the underside of the insert 32 or on the upper side of the plastic part of the bottom wall 3, a gap 37 is created between the insert 32 and upper side of the plastic part of the bottom wall 3, thereby enabling rinsing water to enter said gap 37 at an entry point 33 and drain away at the outlet point 34 into the drainage sump 21. Because of the better drainage possible between the insert 32 and the connecting frame 42 compared to the embodiment shown in FIG. 6, the risk of solid particles accumulating in the gap 37 and possibly causing unpleasant odors is reduced.

In another embodiment not shown in a Figure, the connecting frame 42 preferably consists exclusively of non-corrodible metal, in particular stainless steel, e.g. nickel-chromium steel. The connecting frame in this embodiment can be single- or multi-part. In this embodiment, the connecting frame 42 is therefore implemented as a closed variant. The connecting frame 42 in this embodiment can be fabricated e.g. by deep drawing. In addition to the possibilities described in the other embodiments, the interfaces for connecting the connecting frame 42 to the trough section 40 can also be produced e.g. by welding or seaming. The sealing between connecting frame 42 and trough section 40 can be provided using sealants such as seals and adhesives.

In FIGS. 9 to 11, an open variant of the connecting frame 42 of the base section 53 is illustrated. In this variant of the connecting frame 42, an opening 26 is provided in the plastic part of the bottom wall 3 of the washing compartment 14 on the connecting frame 42, for which reason the joint between insert 32 and connecting frame 42 must be liquid-tight. The insert 32 can, but need not, contribute to the static stability of the plastic connecting frame 42.

FIG. 9 shows a longitudinal section through one half of the connecting frame 42 of the base section 53 as an open variant. The insert 32 as a preformed non-corrodible metal sheet 32, in particular a stainless steel sheet 32, e.g. of nickel-chromium steel, is inserted in the mold at injection molding of the plastic connecting frame 42 and injection molded. This produces a liquid-tight bond between the insert 32 and the rest of the connecting frame 42 that is also sufficiently temperature-resistant. The shaping of the insert 32 is achieved e.g. by deep drawing. By means of special shaping of the insert 32, e.g. by non-corrodible metal strips disposed at right angles to the plane of the insert 32 in the area of the end of the insert 32 (the part which is injection molded), the form-fit and seal-tightness between insert 32 and connecting frame 42 is increased. To improve the seal tightness and temperature resistance, so-called bonding agents can be applied to the insert 32 in the areas which are injection molded. Another alternative are sealants between insert 32 and connecting frame 42, e.g. elastomers such as EPDM or TPE.

FIG. 10 shows a longitudinal section through one half of the connecting frame 42 of the base section 53 as an open variant. The insert 32 as a preformed, e.g. produced by deep drawing, non-corrodible metal sheet 32, in particular a stainless steel sheet 32, e.g. of nickel-chromium steel, is fixed to the connecting frame 42 as an interface using adhesive sections 39, thereby simultaneously producing the required liquid tightness between the insert 32 and the connecting frame 42. The interface of adhesive sections 39 or adhesive areas 39 also ensures the temperature resistance of the bond. Suitable adhesives are required for this purpose.

FIG. 11 shows a longitudinal section through one half of the connecting frame 42 of the base section 53 as an open variant. The insert 32 as a preformed non-corrodible metal sheet 30, in particular a stainless steel sheet 30, e.g. of nickel-chromium steel, or plastic, is fixed to the connecting frame 42 using at least one snap-lock 38. The snap-lock 38 can also be disposed in locations (not shown) other than in FIG. 11. The sealing element 35, e.g. a TPE seal injection molded to the connecting frame 42, ensures the required leak tightness between the insert 32 and the plastic part of the bottom wall 3 of the connecting frame 42.

In this embodiment, as in all the other embodiments or variants described above, instead of a metal insert 32 a plastic insert 32 can also be inserted or, during injection molding of the connecting frame 42, the plastic bottom wall 3 can be implemented such that no additional parts are required, i.e. the entire bottom wall 3 of the washing compartment 14 is fabricated during injection molding of the connecting frame 42.

This means that, using the same mold for injection molding of the connecting frame 42, a bottom wall 3 with a visible metal surface, in particular a stainless steel surface, and a plastic surface can be produced, depending on whether or not a metal part is used. This makes a platform concept possible which is suitable both for low price categories with visible plastic in the bottom of the washing compartment 14 and for upper price categories with a preferably visible stainless steel surface in the bottom of the washing compartment 14.

In addition to the application described above, the technology of overmolding metal parts with plastic can also be used for other applications in a dishwasher. A fixing element, e.g. a fixing ring, for functional components, e.g. a pump sump, or functional components, can be injection molded to the base section 53, in particular to the plastic connecting frame 42 in the area of the drainage sump 21. With the aid of the fixing ring, the pump sump can be indirectly fixed to the connection frame 42 (not shown). In addition, fixing elements for functional components, e.g. also a heat exchanger, or functional components, can also be injection molded onto the walls 11, 17, 18 and 19 of the trough section 40, if consisting of plastic. A heat exchanger is to be understood as meaning a fresh water container which, because of a thermal bond to the walls 11, 17, 18, 19 of the trough section 40, cools the wall 11, 17, 18, 19 during drying so that in this area of the wall 11, 17, 18, 19 the moisture or more specifically water vapor condenses better in order to increase the drying performance.

All in all, the dishwasher according to the invention provides a variable platform concept which exploits the advantages in the manufacturing process of a prior art platform concept in which the plastic mounting base forms the bottom wall of the washing compartment and enables them to be combined with the esthetic and therefore marketing-relevant advantages of a totally stainless steel washing compartment.

1-55. (canceled)

56. A dishwasher, comprising:
a washing compartment formed by a trough section and a base section; and
a connecting frame disposed between the trough section and the base section.

57. The dishwasher of claim 56, wherein the trough section is open to a front and a bottom when the trough section is positioned in an installed position.

58. The dishwasher of claim 56, wherein the base section has a bottom wall.

59. The dishwasher of claim 56, wherein the base section has a base support.

60. The dishwasher of claim 59, wherein the base support is a single-part frame structure.

61. The dishwasher of claim 59, wherein the base support has two foot module bars.

62. The dishwasher of claim 56, wherein the base section has a floor tray.

63. The dishwasher of claim 56, wherein the connecting frame is one of a single-part frame and a multi-part frame.

64. The dishwasher of claim 63, wherein the multi-part frame is a two-part frame.

65. The dishwasher of claim 58, wherein the washing compartment has a visible area, wherein the bottom wall in the visible area of the washing compartment is formed at least partially by one of a foil, an insert of non-corrodible metal, plastic, and a metal sheet of non-corrodible metal, and wherein the one of the foil, the insert, and the metal sheet is connected to remaining parts of the connecting frame via respective interfaces.

66. The dishwasher of claim 65, wherein the foil and the insert of non-corrodible metal is made of stainless steel.

67. The dishwasher of claim 56, wherein the trough section includes a top wall and sidewalls having respective front ends, and wherein a frame is mounted at the respective front ends of the sidewalls and the top wall of the trough section.

68. The dishwasher of claim 56, wherein the connecting frame comprises respective interfaces to connect the connecting frame to at least one of a part of a bottom wall of the base section, a base support of the base section, a frame mounted at respective front ends of sidewalls and a top wall of the trough section, and the trough section.

69. The dishwasher of claim 62, wherein the base section has a base support, and wherein the base support has respective interfaces to connect the base support to at least one of the floor tray and the connecting frame.

70. The dishwasher of claim 62, further comprising functional components, wherein the floor tray is structured to at least one of collect leakage water and protect against damage to the functional components of the dishwasher.

71. The dishwasher of claim 70, wherein the floor tray is structured to protect against mechanical damage to the functional components of the dishwasher.

72. The dishwasher of claim 62, wherein the base section has a base support, and wherein the floor tray has an interface to connect the floor tray to the base support.

73. The dishwasher of claim 67, wherein the frame has an interface to connect the frame to the connecting frame.

74. The dishwasher of claim 56, wherein the trough section comprises a back wall, a left-hand sidewall, a right-hand sidewall, and a top wall.

75. The dishwasher of claim 56, wherein the trough section is at least partially made of one of non-corrodible metal and plastic.

76. The dishwasher of claim 75, wherein the non-corrodible metal is stainless steel.

77. The dishwasher of claim 56, wherein the base section is at least partially made of plastic.

78. The dishwasher of claim 77, wherein the plastic is thermoplastic plastic.

79. The dishwasher of claim 56, wherein the washing compartment has a visible area, and wherein the connecting frame has a liquid-tight and closed bottom wall and one of a foil and a plastic foil in the visible area of the washing compartment.

80. The dishwasher of claim 79, wherein the foil is a metal foil and wherein the plastic foil is made of thermoplastic plastic with a stainless steel effect.

81. The dishwasher of claim 80, wherein the metal foil is a stainless steel foil.

82. The dishwasher of claim 81, wherein the stainless steel foil is a nickel-chromium steel foil.

83. The dishwasher of claim 79, wherein the foil is bonded to the connecting frame by injection molding of a plastic connecting frame.

84. The dishwasher of claim 83, wherein the foil is inserted into a mold for overmolding prior to the injection molding.

85. The dishwasher of claim 56, wherein the connecting frame has a plastic bottom wall and wherein one of:
an insert of non-corrodible metal is placed onto the plastic bottom wall one of with and without liquid-tight sealing against the plastic bottom wall; and
the insert of non-corrodible metal is disposed in a spaced manner from the plastic bottom wall of the connection frame.

86. The dishwasher of claim 85, wherein the non-corrodible metal is stainless steel and wherein gaps are formed by spacers when the insert of non-corrodible metal is disposed in the spaced manner from the plastic bottom wall of the connection frame.

87. The dishwasher of claim 86, wherein the stainless steel is nickel-chromium steel.

88. The dishwasher of claim 85, wherein the connecting frame has a liquid-tight and closed bottom wall.

89. The dishwasher of claim 88, wherein the liquid-tight and closed bottom wall is made of plastic.

90. The dishwasher of claim 76, further comprising sealing elements to seal the insert of non-corrodible metal against the connecting frame.

91. The dishwasher of claim 90, wherein the sealing elements are made of a elastomer selected from the group consisting of EPDM, TPE, and silicone.

92. The dishwasher of claim 58, wherein the bottom wall is at least partially formed by one of a non-corrodible metal sheet, an insert, and plastic, and wherein one of the non-corrodible metal sheet and the insert is sealed against the connecting frame.

93. The dishwasher of claim 92, wherein the non-corrodible metal sheet and the insert are made of stainless steel, and wherein the one of the non-corrodible metal sheet and the insert are sealed against the connecting frame by one of an adhesive section, and adhesive area, and a gapless bond between the one of the non-corrodible metal sheet and the insert.

94. The dishwasher of claim 93, wherein the stainless steel is nickel-chromium steel and wherein the gapless bond is created by back injection-molding.

95. The dishwasher of claim 66, further comprising a snap-lock to connect the insert of non-corrodible metal to the connecting frame.

96. The dishwasher of claim 66, further comprising sealing means to seal one of the metal sheet and the insert against the connecting frame.

97. The dishwasher of claim 96, wherein the sealing means is a TPE seal injection-molded to the connecting frame.

98. The dishwasher of claim 58, wherein the bottom wall has at least one opening.

99. The dishwasher of claim 56, wherein the connecting frame is made entirely of non-corrodible metal, and wherein the connecting frame has a liquid-tight and closed bottom wall.

100. The dishwasher of claim 99, wherein the non-corrodible metal is stainless steel.

101. The dishwasher of claim 100, wherein the stainless steel is nickel-chromium steel.

102. The dishwasher of claim 59, wherein the base support absorbs forces occurring on the base section.

103. The dishwasher of claim 66, wherein arrangements of at least one of the foil, the metal sheet and the insert on the bottom wall of the connecting frame are combined with one another.

104. The dishwasher of claim 56, further comprising a housing, wherein the housing is disposed separately from at least one of the trough section and the base section.

105. The dishwasher of claim 104, wherein the housing is an independent component with respect to the trough section.

106. The dishwasher of claim 104, further comprising a frame structure and fixing means to connect the housing to at least one of the frame structure, the washing compartment and the base section at isolated points.

107. The dishwasher of claim 106, wherein the fixing means are selected from the group consisting of screws, rivets, and clamps.

108. The dishwasher of claim 104, wherein the housing includes at least one wall.

109. The dishwasher of claim 108, wherein the at least one wall is made of coated metal sheet and includes two housing sidewalls and one upper housing wall.

110. The dishwasher of claim 108, wherein the at least one wall is disposed at a predetermined distance away from respective walls of at least one of the trough section and the base section.

111. The dishwasher of claim 110, wherein the predetermined distance ranges from 0.1 cm to 7 cm, and wherein the at least one wall is disposed at the predetermined distance away from the respective walls of the at least one of the trough section and the base support.

112. The dishwasher of claim 56, wherein the base section is a shell structure comprising a bottom wall of the washing compartment, a back wall, two sidewalls, and another bottom wall.

113. The dishwasher of claim 112, wherein the shell structure comprises a front wall.

114. The dishwasher of claim 59, wherein the base section is a shell structure comprising a bottom wall of the washing compartment, a back wall, two sidewalls, and another bottom wall.

115. The dishwasher of claim 114, wherein the shell structure comprises a front wall.

116. The dishwasher of claim 113, wherein the bottom wall of the washing compartment, the back wall, the two side walls, the other bottom wall, and the front wall of the base section have respective openings for repair and maintenance purposes.

117. The dishwasher of claim 115, wherein the bottom wall of the washing compartment, the back wall, the two side walls, the other bottom wall, and the front wall of the base support have respective openings for repair and maintenance purposes.

118. The dishwasher of claim 56, wherein the base section is a frame structure.

119. The dishwasher of claim 59, wherein the base support is a frame structure.

120. The dishwasher of claim 56, wherein the dishwasher is a domestic dishwasher.

121. The dishwasher as claimed in claim 120, wherein the domestic dishwasher is one of a built-in dishwasher, a freestanding dishwasher, a built-under dishwasher, and a fully integrated dishwasher.

122. The dishwasher of claim 56, further comprising functional components, wherein the base section has an interface to connect the base section to the functional components of the dishwasher.

123. The dishwasher of claim 122, wherein the functional components are selected from the group consisting of pumps, valves, electrical connectors, hydraulic connectors, and electrical switches.

124. The dishwasher of claim 59, further comprising functional components, wherein the base support has an interface to connect the base support to the functional components of the dishwasher.

125. The dishwasher of claim 124, wherein the functional components are selected from the group consisting of pumps, valves, electrical connectors, hydraulic connectors, and electrical switches.

126. The dishwasher of claim 56, further comprising functional components and fixings for the functional components, wherein one of the fixings and the functional components is injection-molded to one of the base section and parts of the base section.

127. The dishwasher of claim 126, wherein the functional components are selected from the group consisting of a pump, a heater, electrical connectors, hydraulic connectors, a filter, a pump sump, and a water softener; and wherein the parts of the base section are selected from the group consisting of the connecting frame, a base support, and a floor tray.

128. The dishwasher of claim 56, further comprising functional components and fixings for the functional components, wherein one of the fixings and the functional components is injection-molded to the trough section.

129. The dishwasher of claim 128, wherein the functional components are selected from the group consisting of a pump, a heater, electrical connectors, hydraulic connectors, a filter, a pump sump, a heat exchanger, a water softener; and wherein the one of the fixings and the functional components is injection-molded to walls of the trough section.

130. A method for manufacturing a dishwasher having a walled trough section that is open to a front and a bottom of the trough section and that is disposed on a base section of the dishwasher to form a washing compartment and wherein a bottom wall of the washing compartment is formed by the base section, the method comprising fixing the trough section to a connecting frame as a separate component, wherein the connecting frame includes the bottom wall of the washing compartment.

131. The method of claim 130, further comprising fixing the connecting frame to a base support via an interface.

132. The method of claim 130, further comprising fixing a floor tray to the base support via an interface.

133. The method of claim 130, further comprising fixing a frame to a front end of a left-hand washing compartment wall, a right-hand washing compartment wall, and a washing compartment top wall via an interface.

134. The method of claim 133, wherein the frame and the connecting frame are first fixed to the trough section and then a base support is fixed thereto.

135. The method of claim 134, wherein a floor tray is fixed to the base support.

136. The method of claim 133, wherein the frame is first fixed to the trough section and then the connecting frame with a base support is fixed thereto.

137. The method of claim 130, further comprising fixing a floor tray to a base support.

138. The method of claim 130, further comprising fabricating plastic parts of the base section by injection-molding.

139. The method of claim 130, further comprising fabricating plastic walls of the trough section by injection molding.

140. The method of claim 130, further comprising injection-molding one of fixings for functional components and functional components to parts of the base section.

141. The method of claim 140, wherein the functional components are selected from the group consisting of a pump, a heater, electrical connectors, hydraulic connectors, a filter, a pump sump, and a water softener; and wherein the parts of the base section are selected from the group consisting of the connecting frame, a base support and a floor tray.

142. The method of claim 130, further comprising injection-molding one of fixings for functional components and functional components to the through section.

143. The method of claim 142, wherein the functional components are selected from the group consisting of a pump, a heater, electrical connectors, hydraulic connectors, a filter, a pump sump, a heat exchanger, and a water softener; and wherein the one of the fixings for the functional components and the functional components are injection-molded to walls of the trough section.
